(19) United States
(12) Patent Application Publication
(10) Pub. No.: US 2018/0157385 A1
(43) Pub. Date: Jun. 7, 2018

(54) SYSTEM AND METHOD FOR MENU INTERFACE PRESENTATION

(71) Applicants: Jamdeo Canada Ltd., Oakville (CA); Hisense Electric Co., Ltd., Qingdao, Shandong (CN); Hisense USA Corp., Suwanee, GA (US); Hisense International Co., Ltd., Qingdao, P.R.C. (CN)

(72) Inventors: Sanjiv Sirpal, Oakville (CA); Mohammed Selim, Oakville (CA); Alexander De Paz, Burlington (CA); Saulo Dourado, Oakville (CA)

(73) Assignees: Jamdeo Canada Ltd., Oakville, ON (CA); Hisense Electric Co., Ltd., Qingdao, Shandong (CN); Hisense USA Corp., Suwanee, GA (US); Hisense International Co., Ltd., Qingdao, P.R.C. (CN)

(21) Appl. No.: 15/530,689

(22) Filed: Mar. 31, 2016

(51) Int. Cl. G06F 3/0482; G06F 3/0484

(52) U.S. Cl. CPC G06F 3/0482; H04N 21/4312; G06F 3/0484

(57) ABSTRACT

The present disclosure relates to electronic devices, processes and systems for configuration of a display device. In one embodiment, a method for or presenting a menu interface by a display device includes detecting a command for presentation of a menu interface of the display device, detecting at least one menu interface setting and presenting a menu interface on a display of the display device. The menu interface may be presented to include a plurality of tile elements associated with a control selection for the display device, the tile elements presented in a configuration format and including a tile configured for personalization, and a tile element for selecting content for presentation by the display device. The method also includes tile elements a configuration format, tile configured for personalization and location of the menu interface based on the at least one menu interface setting.

### FIELD

The present disclosure relates to electronic devices and applications, and more particularly to display and content presentation devices.

### BACKGROUND

Television receivers have long been used to present broadcast TV content. Similarly, television receivers have been used to present video content received from standalone players. With advances in networking and developments in providing data to end users, there is a need for systems and methods to present content on display devices such as televisions. Further to that point, there is a need for control interfaces to allow for control of devices without the complexity of conventional TV interfaces.

It can be difficult for device manufactures to menu based configurations that fit all devices across different product markets. Moreover, there exists a desire for interfaces to be customizable. Conventional on-screen interfaces do not allow for customization. Moreover, the conventional interfaces require complex menus with distracting elements and can require extraneous actions for use. There is a desire for modified configurations to optimize control and experience.

### BRIEF SUMMARY OF THE EMBODIMENTS

Disclosed and claimed herein are methods, devices and systems for presenting a menu interface. One embodiment is directed to a method including detecting, by a display device, a command for presentation of a menu interface of the display device, and detecting, by the display device, at least one menu interface setting. The method also includes presenting, by the display device, a menu interface on a display of the display device wherein the menu interface is presented to include a plurality of tile elements, wherein each tile element is associated with a control selection for the display device, wherein the plurality of tile elements are presented in a configuration format, wherein the plurality of tile elements include a tile configured for personalization, wherein the plurality of tile elements include at least one tile element for selecting content for presentation by the display device, wherein the tile elements are presented as an overlay to display screen content presented by the display device, and wherein the configuration format, tile configured for personalization and location of the menu interface are based on the at least one menu interface setting.

In one embodiment, the menu interface is presented by the display device to allow for selection of tile elements to control operation of the display device.

In one embodiment, the menu interface setting defines at least one of a pattern, position, layout and appearance of the plurality of tile elements.

In one embodiment, the menu interface and plurality of tile elements are presented as an overlay bar, the overlay bar including tile elements arranged in a horizontal arrangement.

In one embodiment, the menu interface is presented as an overlay pattern including the plurality of tile elements, wherein tile elements are presented in one or more row and columns.

In one embodiment, the tile configured for personalization includes a user defined image and one or more graphical elements associated with a user of the display device.

In one embodiment, the menu interface setting is a user selected feature modifying a preloaded configuration for the menu interface to at least one of a set of predefined menu interface configurations.

In one embodiment, the configuration format, tile configured for personalization and location of the menu interface are received by the display device based on a network communication with at least one server.

In one embodiment, the menu interface further includes presentation of at least one panel view based on a detected selection of the menu interface by the display device.

In one embodiment, the method also includes presenting graphical elements by the display device during at least one of power-on and power-down operations of the display device.

Another embodiment is directed to a device including a display configured to present a menu interface and a controller coupled to the display. The controller configured to detect a command for presentation of a menu interface of the display device, detect at least one menu interface setting and present a menu interface on a display of the display device. The menu interface is presented to include a plurality of tile elements, wherein each tile element is associated with a control selection for the display device, wherein the plurality of tile elements are presented in a configuration format, wherein the plurality of tile elements include a tile configured for personalization, wherein the plurality of tile elements include at least one tile element for selecting content for presentation by the display device, wherein the tile elements are presented as an overlay to display screen content presented by the display device, and wherein the configuration format, tile configured for personalization and location of the menu interface are based on the at least one menu interface setting.

In one embodiment, the menu interface is presented by the display device to allow for selection of tile elements to control operation of the display device.

In one embodiment, the menu interface setting defines at least one of a pattern, position, layout and appearance of the plurality of tile elements.

In one embodiment, the menu interface and plurality of tile elements are presented as an overlay bar, the overlay bar including tile elements arranged in a horizontal arrangement.

In one embodiment, the menu interface is presented as an overlay pattern including the plurality of tile elements, wherein tile elements are presented in one or more row and columns.

In one embodiment, the tile configured for personalization includes a user defined image and one or more graphical elements associated with a user of the display device.

In one embodiment, the menu interface setting is a user selected feature modifying a preloaded configuration for the menu interface to at least one of a set of predefined menu interface configurations.

In one embodiment, the configuration format, tile configured for personalization and location of the menu interface are received by the display device based on a network communication with at least one server.

In one embodiment, the menu interface further includes presentation of at least one panel view based on a detected selection of the menu interface by the display device.

In one embodiment, the device presents graphical elements by the display device during at least one of power-on and power-down operations of the display device

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of display device menu interface according to one or more embodiments;

FIG. 2 depicts a process for configuring a menu interface of a display device according to one or more embodiments;

FIG. 3 depicts a process for presentation of a menu interface of a display device according to one or more embodiments;

FIG. 4 depicts a simplified system diagram according to one or more embodiments;

FIG. 5 depicts a graphical representation of display device operation according to one or more embodiments;

FIG. 6 depicts a graphical representation of a display device menu interface according to one or more embodiments;

FIG. 7 depicts a graphical representation of a display device menu interface according to one or more embodiments;

FIG. 8 depicts a graphical representation of a panel view according to one or more embodiments; and

FIG. 9 depicts a graphical representation of a panel view according to one or more embodiments.

### DETAILED DESCRIPTION OF THE EXEMPLARY EMBODIMENTS

### Overview and Terminology

One aspect of the disclosure relates to display device operation, and in particular systems and methods for configuration of a display device. A display device may relate to a TV or monitor unit for presentation of content. A display device may relate to a traditional type of TV for viewing broadcast content. Display device may also apply to devices configured to receive content from one or more input sources channels, such as network, streaming, on demand, etc. Display devices may be configured with various inputs or connections. With advances in display devices, there is a desire to retain controllability with a simple remote control having a numerical key pad and directional commands while allowing for configuration of the display device user interface. Users of display devices have varying capabilities. Some users may prefer a simple configuration for controlling. Others desire a rich experience and customization.

One or more embodiments discussed herein overcome problems arising in graphical user interface presentation and streamline control commands. In one embodiment a menu interface is provided for a display device. The menu interface is presented as an overlay and allows for customization of the elements of the interface by a user and/or a display device.

According to one embodiment, a system and method are provided for configuring a display device, such as a smart TV or cinema display (playback device). The configuration may be based on a display device configured to allow for simplified management of settings (brightness/contrast) with pre-canned image modes, and sound modes (no user settings on TV). According to one embodiment, complex features and management functionality may be configured to occur outside the TV menus (i.e. network/cloud based configuration).

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

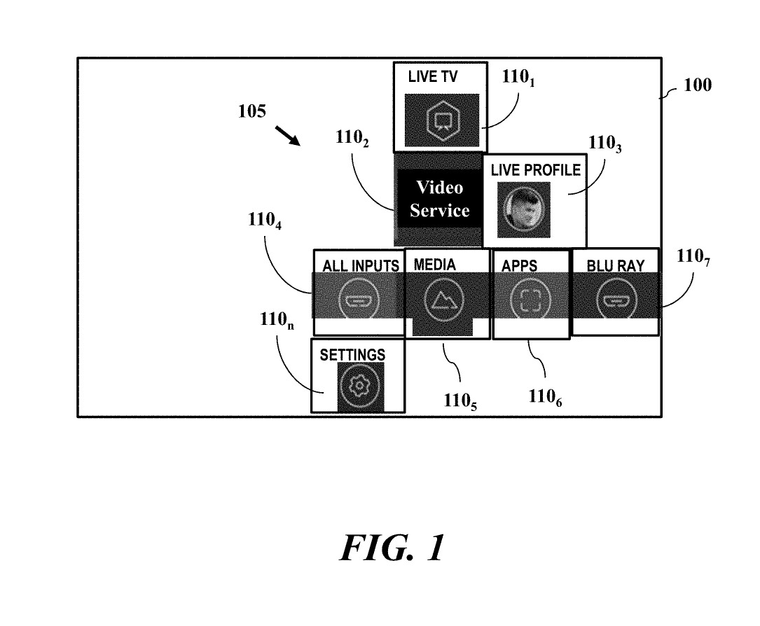

Referring now to the figures, FIG. 1 depicts a graphical representation of menu interface presentation by a display device according to one or more embodiments. A display device having display 100 is configured to present menu interface 105 including a plurality of tiles elements 110₁₋ₙ. According to one embodiment, presentation of menu interface 105 is configured to provide control of the display device, such as selection of an input source, selection of a particular channel, selection of display content, settings, presentation of personalized information, etc.

According to one embodiment, a display device is configured to present menu interface 105 according to one or more layout configurations. FIG. 1 depicts menu interface 105 including a plurality of tile elements 110₁₋ₙ in a configuration including an uneven distribution of tiles in multiples row and columns. Menu interface 105 is depicted occupying a portion of display 100, it should be appreciated that additional or fewer tile elements may be presented in menu interface 105. Menu interface 105 may be presented over content displayed by the display device, which may be background graphics for a home screen configuration and/or video content, such as displayed broadcast content received by the display device.

According to one embodiment, the presentation of tile elements may be configured based on a subset of tile elements accessible to display device such that the layout may remain the same with particular tiles being replaced based on tiles that are frequently selected. Tile element 110₁ may be selected from presentation of live TV by display 100.

Exemplary representations of the plurality of tile elements 110₁₋ₙ are shown in FIG. 1. Tile element 110₂ may be selected for presentation by one or more video sources (e.g., streaming services, etc.) by display 100. Tile element 110₃ may be a personalized tile element. Tile element 110₄ may be selected for inputs/sources of the display device. Tile element 110₅ may be selected for presentation of media accessible to the display device (e.g., stored media, recorded, on demand, etc.). Tile element 110₆ may be selected for presentation applications of the display device. Tile element 110₇ may be selected for selection of a media player (i.e., blue ray player, etc.). Tile element 110ₙ may be selected for a settings panel of the display device.

According to one embodiment, the selected tile element may be presented with graphical treatment such as increase size relative to other tile element, glow, shadow, etc. to indicate which element is highlighted. The highlight position may be moved relate to tile elements of menu interface 105 to select a particular element. Manipulation of a highlighted element may be performed by a directional pad of a remote control and/or touch screen commands for touch-sensitive displays.

According to one embodiment, a display device and one or more elements of the display device are configured to provide menu interface 105 to allow for customization by users and allows for quick access to any application or input of the display device. Configuration of the tiles allows for optimized experience and function and resolves the issue of navigation lengthy menus be removing one or more steps for access to features of a display device. IN addition, presentation of the menu allows for simplification of other control elements, such as remote controls, relative to the operation of the display device.

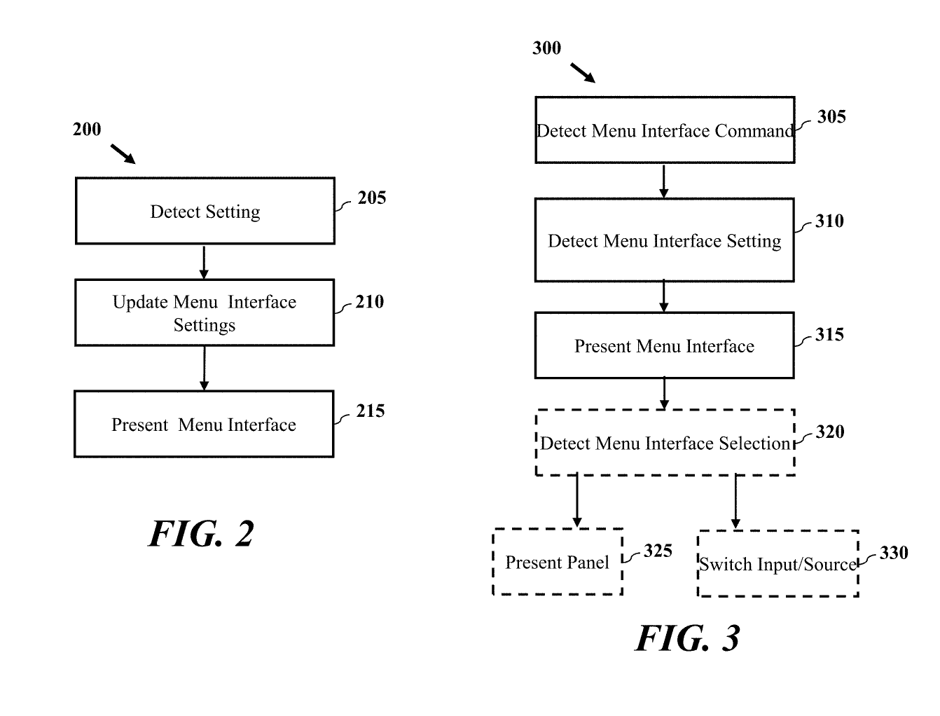

FIG. 2 depicts a process for configuring a menu interface of a display device according to one or more embodiments. Process 200 may be employed to configure one or more elements of a menu interface (e.g., menu interface 105). By way of example, process 200 may be employed to modify initial configuration of a menu interface of a display device. Process 200 may be performed by a display device.

Process 200 may be initiated by detecting a setting for a menu interface at block 205. The detected setting may be input by a user via a settings tile of the menu interface. In certain embodiments, the detected setting relates to a selection of a pre-established menu interface configuration that is different from the menu interface currently loaded to the display device.

A menu interface for the display device may be preloaded having a particular configuration, such as an overlay bar with tile elements. The menu interface may also have features and configures that are either preloaded but locked, or accessible to the device based on one or more user requests. Preloaded parameters for a menu interface can include one or more of pattern, position, layout and appearance. Parameters for the menu interface may be modified by the user to include customization of one or more parameters. Customization can include selection of a particular layout, addition/deletion of tiles, and changes to appearance (e.g., color schemes, graphical treatment, etc.).

In certain embodiments, the setting detected at block 205 unlocks the configuration of the menu interface. In other embodiments, the setting detected at block 205 allows for access of the menu interface configuration(s) from a network site (e.g., server, cloud, etc.). The display device may allow for presentation and selection of one or more overlay elements, configuration changes, applications, and editing of a navigation bar for a display device. According to one embodiment, the control device interoperates with a companion application to the application/operating software of the display device.

At block 205, a user may select an application to add to a navigation bar of a display device. As such, the control device may issue a configuration change including the addition of an application for inclusion in the navigation bar. Alternatively, or in combination, the configuration change includes at least one of a modification to features available for selection in the navigation bar and layout of the navigation bar. According to another embodiment, user settings received at block 205 may relate to selection or indication of one or more overlays for a display device.

At block 210, the display device can update the menu interface and/or one or more menu interface settings. Based on the update at block 210, the display device can present the menu interface at block 215. In certain embodiments, the menu interface is presented at startup and/or when requested

FIG. 3 depicts a process for presentation of a menu interface of a display device according to one or more embodiments. Process 300 may be initiated by detecting a command for a menu interface at block 305. At block 310, in response to the menu interface command, process 300 detects one or more user interface settings. A menu interface setting defines at least one of a pattern, position, layout and appearance of the plurality of tile elements. In certain embodiments, once a user interface is configured, user interface setting detected at block 310 may not include layout or modifications to the layout. Instead, user interface settings may relate to selection of tile elements for the menu interface. Menu interface settings detected at block 310 can include configurations settings and updates relative to the previous display of the menu interface. In one embodiment, the menu interface setting is a user selected feature modifying a preloaded configuration for the menu interface to at least one of a set of predefined menu interface configurations. According to another embodiment, the configuration format, tile configured for personalization and location of the menu interface are received by the display device based on a network communication with at least one server.

Process 300 can present the user interface at block 315. In one embodiment, a menu the menu interface is presented to include a plurality of tile elements. The menu interface is presented by the display device to allow for selection of tile elements to control operation of the display device. Each tile element is associated with a control selection for the display device. The plurality of tile elements may be presented in a configuration format, such as the menu interface configuration provided by a manufacturer, or customized by a user. As such, the plurality of tile elements can include a tile configured for personalization.

According to one embodiment, the plurality of tile elements presented at block 315 include at least one tile element for selecting content for presentation by the display device, wherein the tile elements are presented as an overlay to display screen content presented by the display device, and wherein the configuration format, tile configured for personalization and location of the menu interface are based on the at least one menu interface setting. In one embodiment, the tile configured for personalization includes a user defined image and one or more graphical elements associated with a user of the display device. In one embodiment, the menu interface and plurality of tile elements are presented as an overlay bar, the overlay bar including tile elements arranged in a horizontal arrangement. In another embodiment, the menu interface is presented as an overlay pattern including the plurality of tile elements, wherein tile elements are presented in one or more row and columns.

Presentation of a menu interface at block 315 can be based on one or more configurations including but not limited to overlays, a bottom band, center overlay, a desktop configuration, and one or more customized configurations.

Following presentation of a menu interface (e.g., menu interface 105) at block 315, process 300 can allow for interaction with the menu interface. Process 300 optionally includes detecting a menu interface selection at block 320 which can include selection of a tile of the menu interface. Based on a detected selection of the menu interface, process 300 can optionally present a panel associated with the selected tile at block 325 or switch to another input/source at block 330 based on a selection of an input/source.

Process 300 may be employed by a control device to provide one or more settings to a display device. Process 300 may also include presenting graphical elements during at least one of power-on and power-down operations of the display device.

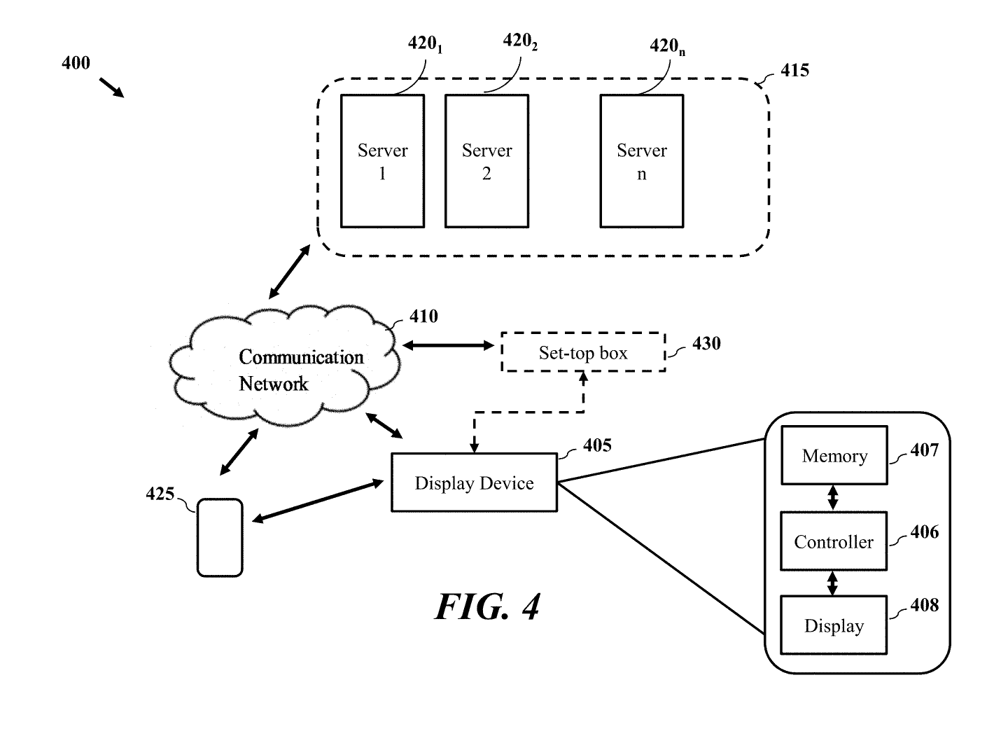

FIG. 4 depicts a simplified system diagram according to one or more embodiments. System 400 includes display device 405. System 400 allows for display device 405 to configure a menu interface. By way of example, configuration of display device 405 can allow for one or more menu interface settings to be configured, modified or updated. By way of further example, configuration of display device 405 can allow for functionality of display device 405 to be unlocked. In certain embodiments, configuration of display device 405 includes customizing presentation of overlay items, such as navigation menus. In other embodiments, configuration of display device 405 allows for adding one or more display attributes associated with control and/or operation of display device 405.

Display device 405 as shown in FIG. 4 includes a controller 406 coupled to memory 407 and a display 408. Display device 405 may relate to television or display device in general configured to provide video or image output from one or more selected sources or channels. Display device 405 may be controlled by a remote control, such as remote control with directional pad. In certain embodiments, display device 405 may be configured as a smart TV or a cloud/linux based, always connected cinema TV for instant on video-on-demand (VOD) consumption. Display device 405 may be configured to provide cloud based content in addition to broadcast TV content. Display device 405 may multi-device aware of other TV's, companion devices, and accessories.

As shown in FIG. 4, system 400 allows for communicate with display device 405 by way of communication network 410 which may be a local network (e.g., LAN, etc.), cellular, internet, or other communication network. Display device 405 may interoperate with a set-top box 430 which may be optional.

According to another embodiment, display device 405 may be configured to communicate via communication network 410 with one or more cloud based servers. System 400 depicts cloud 415 including servers 420₁₋ₙ according to one or more embodiments. Display device 405 may communicate with one or more of servers 420₁₋ₙ for content and/or configuration for display device 405.

As will be discussed in more detail below, display device 405 may be configured to modify one or more settings for presentation of display elements, such as an overlay element or navigation bar associated with a menu interface. Settings of the display device may be modified based on one or more changes to the overlay element or navigation bar. According to one embodiment, configuration changes may corresponds to a release or unlocking of one or more features previously included and inaccessible to settings for presentation of the overlay element by the display device. By way of example, display devices may typically be shipped to customers with a preset configuration. However, features of display device 405 may require a user to unlock or configure certain features. In that fashion, the display device 405 may be shipped with a light weight configuration and simple operation while also allowing for customization.

Display device 405 may be configured to receive configuration changes from control device 425, and one or more other control devices, for configuring the display device. Following configuration, display device 405 can, for example, present a menu interface based on the configuring.

Control device 425 relates to electronic device having a display and a network connection. Control device 425 may relate to a mobile device or personal connection device running an application that allows for configuration of display device 405, such as drag and drop, adding, removal and editing layout and content of a menu interface configuration.

Control device 425 may be a companion device, or device operating an application that is associated with the user interface controls of the display device. Control device 425 may be a mobile device (e.g., personal communication device, etc.) or mobile computing device (e.g., personal computer, tablet, etc.). Control device 425 in some embodiments may be configured to operate as a remote control for traditional display device such as channel tuning, volume control, picture correction, etc.

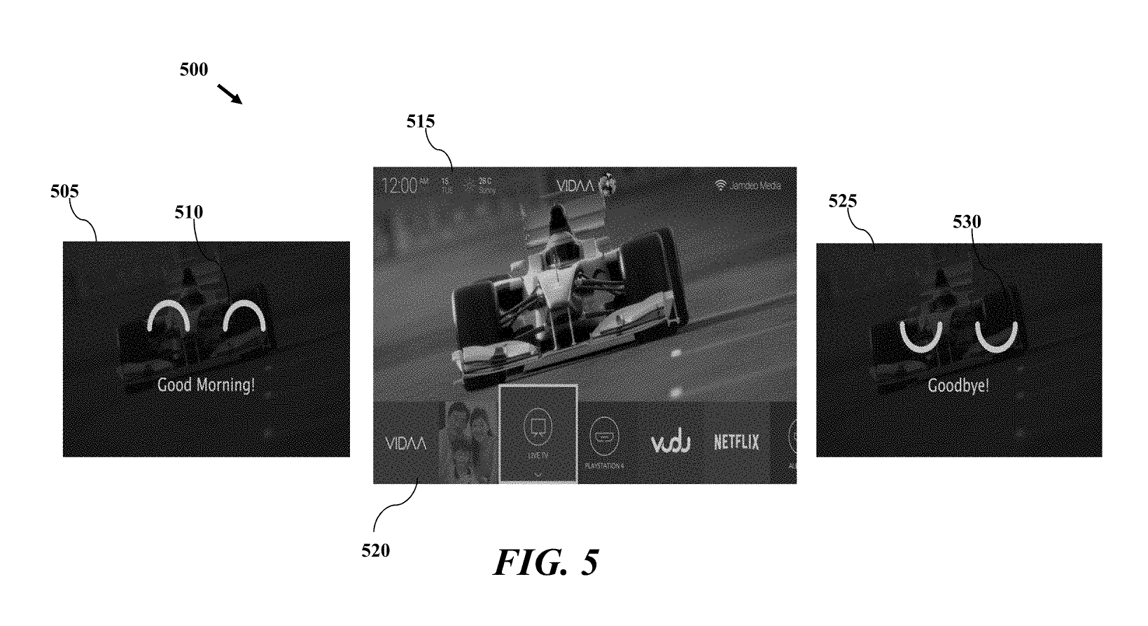

FIG. 5 depicts a graphical representation of display device operation according to one or more embodiments. According to one embodiment, a display device may be configured to provide a cinematic experience from power on to power off. FIG. 5 depicts an exemplary presentation format 500 for a display device according to one or more embodiments.

According to one embodiment, at power on 505 of a display device, the display device may be configured to present power on graphical elements 510 followed by display of content 515 including menu interface 520. At power down 525, the display device may be configured to present power down graphical elements 530.

Graphical elements 510 associated with power on 505 include display elements and text. Similarly, graphical elements 530 associated with power down 525 can include display elements and text. According to one embodiment, presentation of graphical elements 510 and 530, and their content may be established and/or modified based on one or more settings detected for a menu interface, such as menu interface 520. By way of example, the text message associated with graphical elements 510 and 530 can be modified by the display device. Similarly, the presence of graphical elements, which graphical elements, presence of text and text to display can also be modified, removed and/or included. In that fashion, customer settings can provide a cinematic experience from power on to power off. In addition, graphical elements 510 and 530 may be adjusted per functions of the display device, such that the image and text associated with graphical elements 530 may be modified for a sleep function of the display device.

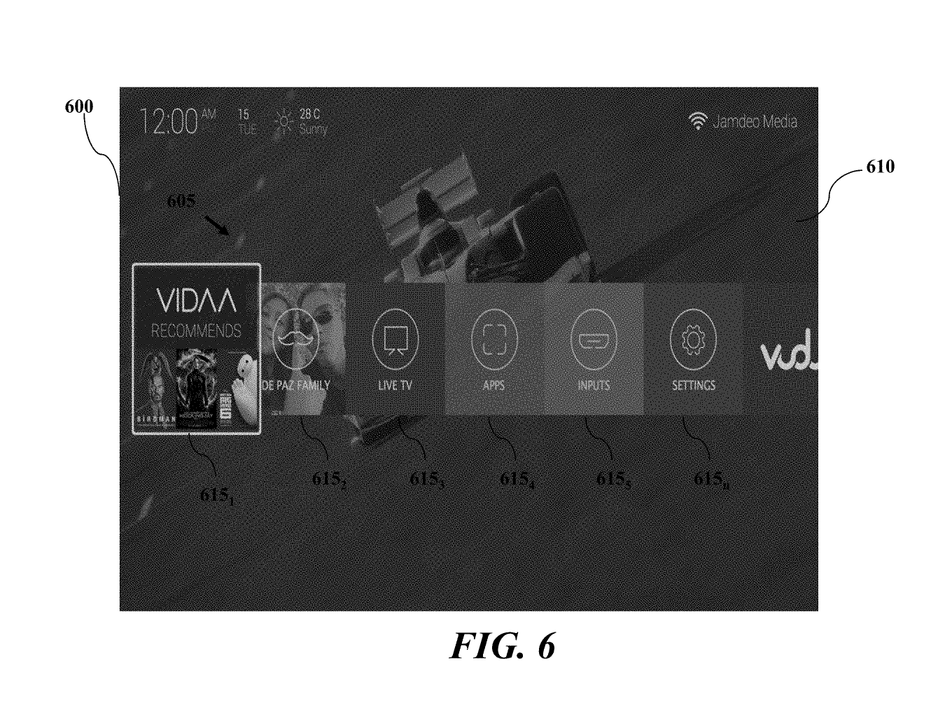

FIG. 6 depicts a graphical representation of a display device menu interface according to one or more embodiments. Display 600 includes menu interface 605 presented as a middle bar overlay according to one or more embodiments. Menu interface 605 is presented above a semi-obscured/faded representation of content 610 presented by display 600. Exemplary tile elements in menu interface 600 include recommendation tile element 615₁, personalization tile element 615₂, live TV tile element 615₃, application tile element 615₄, display device inputs tile element 615₅, and settings tile element 615ₙ.

Personalization tile element 615₂ can include a link to one or more media files or content that is recommended for viewing. Live TV tile element 615₃ can transition to live broadcast of television. Application tile element 615₄ provides a link to applications available to the device. Display device inputs tile element 615₅ allows for selection of one or more sources to the display device and settings tile element 615ₙ can launch a graphical settings menu. Menu interface 605 can be configured customization of applications and to allow users to create the experience they desire and for personalization through usage. Menu interface 605 may be configured for cloud enabled customization by region and for deployment of custom configurations to any targeted region or group.

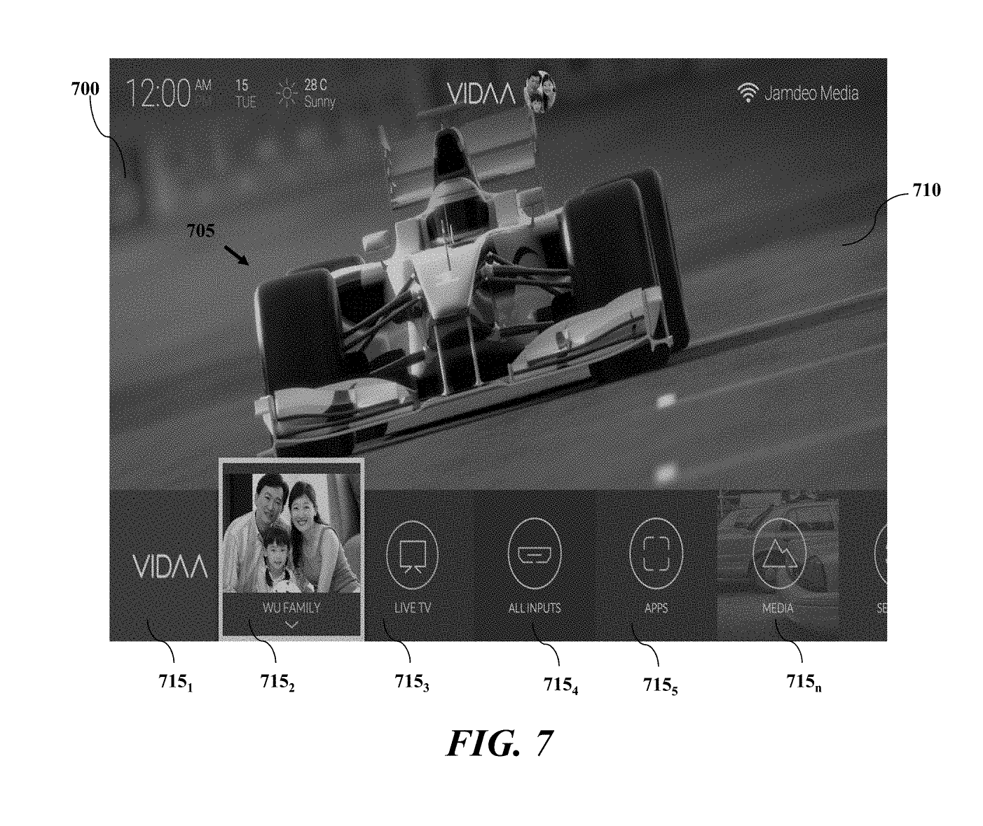

FIG. 7 depicts a graphical representation of a display device menu interface according to one or more embodiments. Display 700 includes menu interface 705 presented as a bottom bar overlay according to one or more embodiments. Menu interface 705 is presented above a content 710 presented by display 700. Exemplary tile elements in menu interface 705 include recommendation tile element 715₁, personalization tile element 715₂, live TV tile element 715₃, input sources 715₄, applications tile element 715₅, and media tile element 715ₙ.

Menu interface 705 may be a bottom bar design configured to provide a modern, dramatic and iconic interface having simple overlay design with quick accesses to any application or input of the display device. A default layout of menu interface 705 may provide access to key items while allowing for customized tiles based on user preferences.

In certain embodiments, the men interface 705 relates to a silo strip containing all sources or applications that are considered ‘SILOS’, wherein the strip can be presented with an order by last use.

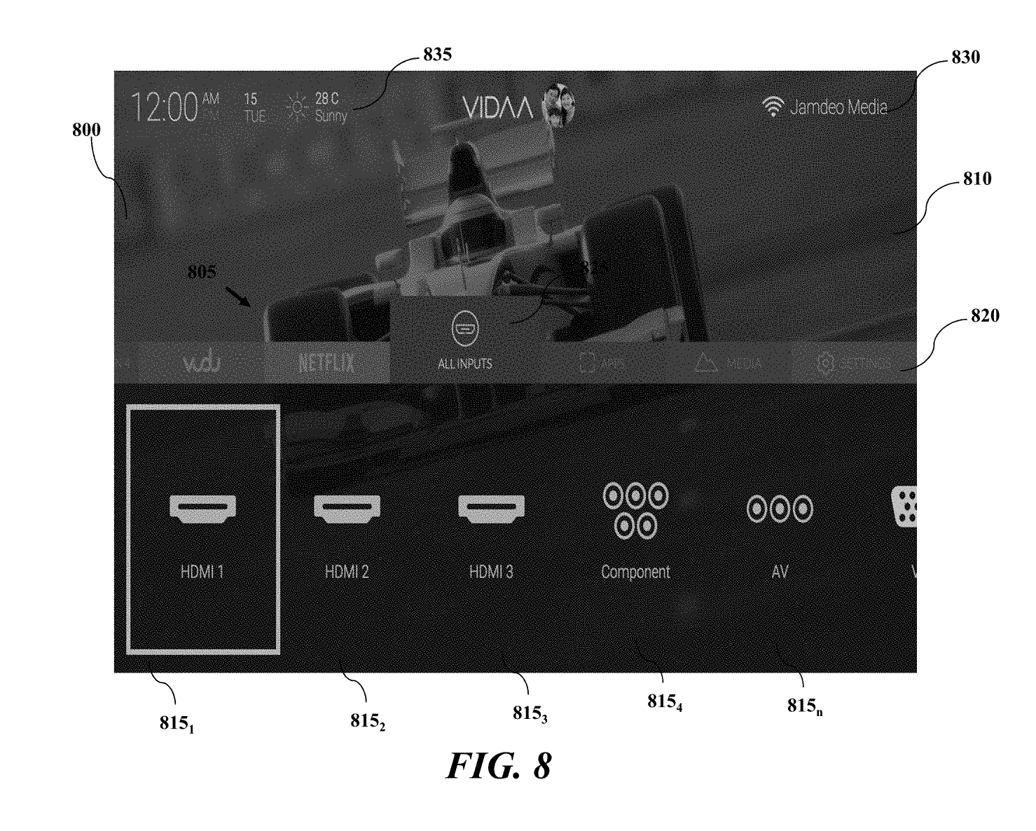

FIG. 8 depicts a graphical representation of a panel view according to one or more embodiments. Display 800 includes an exemplary representation for panel configuration 805. According to one embodiment, a panel configuration is displayed as an overlay on content 810 presented by display 800 in response to selections of a menu interface. Panel configuration relates to an exemplary configuration associated with bottom bar menu interfaces (e.g., menu interface 705).

According to one embodiment, panel configuration 805 is an extension of a menu interface based on the selected tile. Panel configuration 805 includes a plurality of tiles 815₁₋ₙ associated with selected tile 825. Panel configuration 805 also includes bar 820 associated with tiles of the menu interface, wherein selections of bar 820 update the tiles presented in panel configuration 805.

Exemplary tile elements in panel configuration interface 805 include recommendation HDMI 1 tile 815₁, HDMI 2 tile 815₂, HDMI 3 tile 815₃, components inputs 815₄, and AV source 815ₙ.

According to one embodiment, display 800 may include a graphical element identifying a source of content, shown as 830 and/or a widget 835 based on one or more configurations provided by a user.

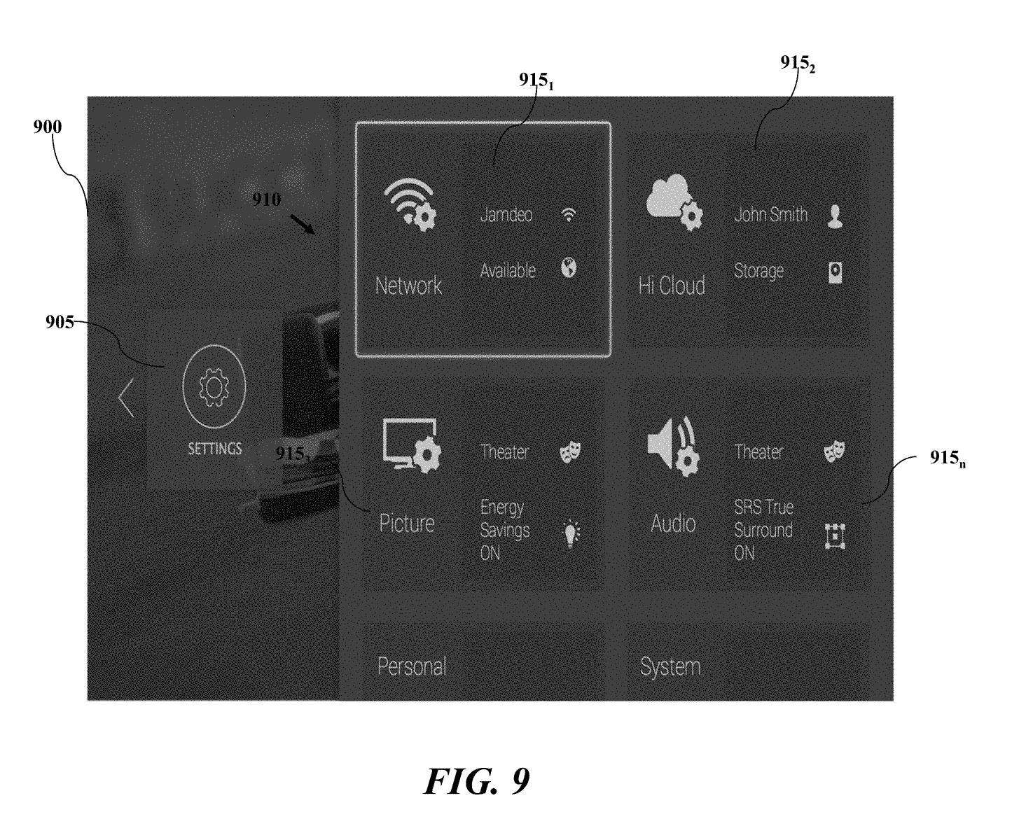

FIG. 9 depicts a graphical representation of a panel view according to one or more embodiments. Display 900 includes an exemplary representation for a settings panel configuration 905. According to one embodiment, a panel configuration is displayed as an overlay on content 910 presented by display 900 in response to selections of a menu interface. Panel configuration 905 relates to an exemplary configuration associated with center bar menu interfaces (e.g., menu interface 605).

According to one embodiment, panel configuration 905 is an extension of a menu interface based on the selected tile. Panel configuration 905 includes a plurality of tiles 915₁₋ₙ associated with network settings tile 915₁, cloud settings tile 915₂, picture settings tile 915₃, and audio settings tile 915₄.

While this disclosure has been particularly shown and described with references to exemplary embodiments thereof, it will be understood by those skilled in the art that various changes in form and details may be made therein without departing from the scope of the claimed embodiments.

What is claimed is:

1. A method for presenting a menu interface by a display device, the method comprising:
detecting, by a display device, a command for presentation of a menu interface of the display device;
detecting, by the display device, at least one menu interface setting;
presenting, by the display device, a menu interface on a display of the display device wherein the menu interface is presented to include
a plurality of tile elements, wherein each tile element is associated with a control selection for the display device,
wherein the plurality of tile elements are presented in a configuration format,
wherein the plurality of tile elements include a tile configured for personalization,
wherein the plurality of tile elements include at least one tile element for selecting content for presentation by the display device,
wherein the tile elements are presented as an overlay to display screen content presented by the display device, and
wherein the configuration format, tile configured for personalization and location of the menu interface are based on the at least one menu interface setting.

2. The method of claim 1, wherein the menu interface is presented by the display device to allow for selection of tile elements to control operation of the display device.

3. The method of claim 1, wherein the menu interface setting defines at least one of a pattern, position, layout and appearance of the plurality of tile elements.

4. The method of claim 1, wherein the menu interface and plurality of tile elements are presented as an overlay bar, the overlay bar including tile elements arranged in a horizontal arrangement.

5. The method of claim 1, wherein the menu interface is presented as an overlay pattern including the plurality of tile elements, wherein tile elements are presented in one or more row and columns.

6. The method of claim 1, wherein the tile configured for personalization includes a user defined image and one or more graphical elements associated with a user of the display device.

7. The method of claim 1, wherein the menu interface setting is a user selected feature modifying a preloaded configuration for the menu interface to at least one of a set of predefined menu interface configurations.

8. The method of claim 1, wherein the configuration format, tile configured for personalization and location of the menu interface are received by the display device based on a network communication with at least one server.

9. The method of claim 1, wherein the menu interface further includes presentation of at least one panel view based on a detected selection of the menu interface by the display device.

10. The method of claim 1, further comprising presenting graphical elements by the display device during at least one of power-on and power-down operations of the display device.

11. A device comprising:
a display configured to present a menu interface;
a controller coupled to the display, the controller configured to
detect a command for presentation of a menu interface of the display device;
detect at least one menu interface setting;
present a menu interface on a display of the display device wherein the menu interface is presented to include
a plurality of tile elements, wherein each tile element is associated with a control selection for the display device,
wherein the plurality of tile elements are presented in a configuration format,
wherein the plurality of tile elements include a tile configured for personalization,
wherein the plurality of tile elements include at least one tile element for selecting content for presentation by the display device,
wherein the tile elements are presented as an overlay to display screen content presented by the display device, and
wherein the configuration format, tile configured for personalization and location of the menu interface are based on the at least one menu interface setting.

12. The device of claim 11, wherein the menu interface is presented by the display device to allow for selection of tile elements to control operation of the display device.

13. The device of claim 11, wherein the menu interface setting defines at least one of a pattern, position, layout and appearance of the plurality of tile elements.

14. The device of claim 11, wherein the menu interface and plurality of tile elements are presented as an overlay bar, the overlay bar including tile elements arranged in a horizontal arrangement.

15. The device of claim 11, wherein the menu interface is presented as an overlay pattern including the plurality of tile elements, wherein tile elements are presented in one or more row and columns.

16. The device of claim 11, wherein the tile configured for personalization includes a user defined image and one or more graphical elements associated with a user of the display device.

17. The device of claim 11, wherein the menu interface setting is a user selected feature modifying a preloaded configuration for the menu interface to at least one of a set of predefined menu interface configurations.

18. The device of claim 11, wherein the configuration format, tile configured for personalization and location of the menu interface are received by the display device based on a network communication with at least one server.

19. The device of claim 11, wherein the menu interface further includes presentation of at least one panel view based on a detected selection of the menu interface by the display device.

20. The device of claim 11, further comprising presenting graphical elements by the display device during at least one of power-on and power-down operations of the display device.
